(19) United States
(12) Patent Application Publication
(10) Pub. No.: US 2008/0298527 A1
(43) Pub. Date: Dec. 4, 2008

(54) DIRECT DIGITAL FREQUENCY SYNTHESIZER WITH PHASE SELECTABLE INTERPOLATOR

(76) Inventors: Reza Adhami, Madison, AL (US); Ashkan Ashrafi, Huntsville, AL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/780,344

(22) Filed: Jul. 19, 2007

Related U.S. Application Data
(60) Provisional application No. 60/941,555, filed on Jun. 1, 2007.

(51) Int. Cl. H04L 7/04

(52) U.S. Cl. 375/362

(57) ABSTRACT

The disclosure relates to improved direct digital frequency synthesizers. A synthesizer in one embodiment is comprised of an accumulator that provides a phase signal and an interpolator having two or more interpolation polynomials. The polynomial that processes the phase signal is selected by comparing the phase signal to a threshold value. A reduced complexity digital circuit is provided for implementing the improved synthesizer.

### CROSS REFERENCE TO RELATED APPLICATION

This document claims priority to U.S. Provisional Application No. 60/941,555 application entitled “Direct Digital Frequency Synthesizer with Phase-Selectable Interpolator,” and filed on Jun. 1, 2007, which is incorporated herein by reference.

### BACKGROUND

A communication system or a radar system often incorporates a direct digital frequency synthesizer (DDFS) as an element of a transmitter or a receiver. A DDFS generally has useful characteristics such as high resolution tuning and fast frequency hopping that can enhance system performance and provide desired features. In order to generate a desired frequency, the DDFS receives a control signal, typically a number, representing step size. The control signal is received by an accumulator within the DDFS. The accumulator also receives a reference clock signal as an input. The output of the accumulator is a phase signal with a frequency that is dependent on the step size and the frequency of the reference clock. The phase signal, a sequence of numbers generally having a sawtooth shape, is coupled to a phase-to-sine mapper (PSM). The PSM provides another sequence of numbers that is a digital sinusoidal signal. The digital sinusoidal signal is sometimes utilized within a digital communication system as a carrier signal for a modulator or a demodulation process. The digital sinusoid signal for other applications is converted to an analog signal by a digital-to-analog converter providing an analog sinusoidal signal. The analog sinusoid signal is then processed by analog components of a communication system or radar system. In general, it is desirable for both the digital sinusoid signal and the analog sinusoid signal to be relatively free of noise, such as frequency spurs, that may be generated in the synthesis process.

In one prior art synthesizer, polynomial coefficients are retrieved from a lookup table. The polynomial coefficients are used in an interpolation polynomial that converts a phase signal into a sinusoidal signal. Another prior art synthesizer is based on angle rotation methods. The spectral purity of a synthesizer is defined by the spurious free dynamic range (SFDR) of the synthesizer. A synthesizer having a SFDR of about 70 dBc. or greater provides a sinusoid of high quality.

The complexity and expense of a DDFS generally increases with an increase in signal quality. Further, the power required generally increases as complexity increases. Hence, there is a need for a DDFS of reduced complexity that provides a quality sinusoidal signal. Associated with conventional DDFS are reference clocks that have frequencies several Hertz (Hz) up to over 1 Giga-Hertz (GHz). The output frequency of a DDFS is generally limited to around 45% of the frequency of the reference clock because of limitations based primarily on the Nyquist sampling rate.

There is a need for an improved DDFS that provides a quality signal and has reduced complexity. Reducing the complexity would save power and reduce the size of the integrated circuit used to provide the digital sinusoidal signal.

### SUMMARY OF THE DISCLOSURE

The disclosure describes an improved direct digital frequency synthesizer for providing sinusoidal signals.

In one exemplary embodiment, a synthesizer comprises an accumulator that provides a phase signal. An interpolator receives the phase signal and selects a set polynomial coefficients from sets of polynomial coefficients in response to a comparison of the phase signal to a threshold value. The interpolator processes the phase signal using the selected coefficients thereby generating a sinusoidal signal.

An exemplary method embodiment for providing a digital sinusoid comprises the steps of generating a phase signal, selecting a set of polynomial coefficients from sets of coefficients wherein the coefficients represent two or more interpolation polynomials, and processing the phase signal using the selected set of coefficients.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram of a conventional DDFS.

FIG. 2 depicts an exemplary embodiment of a synthesizer in accordance with the present disclosure.

FIG. 3 shows an exemplary sinusoidal curve for an embodiment of a synthesizer, such as is depicted by FIG. 2.

FIG. 4 shows exemplary performance curves for an embodiment of a synthesizer, such as is depicted by FIG. 2.

FIG. 5 depicts an exemplary embodiment of a synthesizer, such as is depicted by FIG. 2.

FIG. 6 depicts exemplary waveforms at locations on the block diagram of FIG. 5.

FIG. 7 depicts a conditional complementor that may be used in the exemplary synthesizer shown in FIG. 5.

FIG. 8 depicts an exemplary format converter that may be use in the exemplary synthesizer shown in FIG. 5.

FIG. 9 depicts a table of exemplary coefficients for an embodiment of the synthesizer shown in FIG. 5.

FIG. 10 depicts exemplary performance results for the synthesizer of FIG. 2 with parameter values from the table of FIG. 9.

FIG. 11 depicts an exemplary method embodiment for a synthesizer, such as is depicted by FIG. 2.

### DETAILED DESCRIPTION

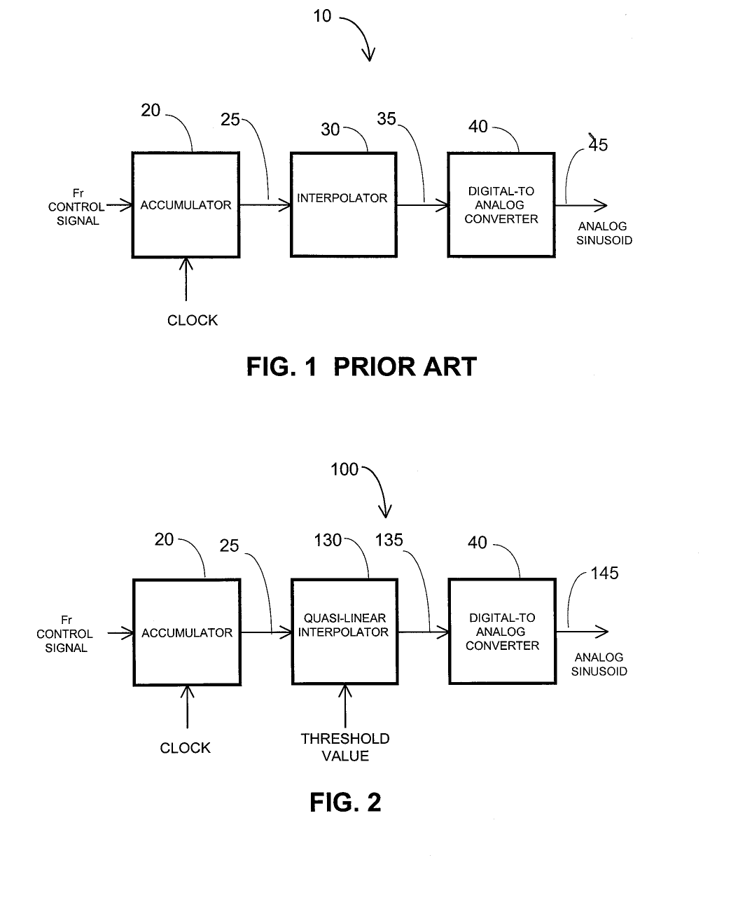

A conventional direct digital frequency synthesizer (DDFS) 10 is typically comprised of an accumulator 20 and an interpolator 30, as shown in FIG. 1. The accumulator 20 provides a phase signal 25, x, that is sequence of numbers, for processing by interpolator 30. The frequency of the phase signal is dependent on the frequency of the accumulator clock, f_{clk}, and the value of a control signal, Fᵣ. The interpolator 30 responds to the phase signal 25 by generating another sequence of numbers representing a sinusoidal signal 35, S. The quality or purity of the sinusoidal signal 35 is measurable and dependent on a variety of factors as will be seen. When the sinusoidal signal 35 is converted to the continuous time domain by a digital-to-analog converter 40, the sinusoidal signal becomes a continuous time domain sinusoid 45, s(t).

The phase signal 25 usually has a sawtooth shape, is periodic and has values that span all four quadrants. The output of the interpolator 30 is a sequence of digital numbers that represents the sinusoid signal 35. When the interpolator 30 receives phase signal 25 from the accumulator 20, the interpolator 30 processes, using an interpolation algorithm, the phase signal 25 to generate the sinusoid signal 35. The interpolator 30 is also referred to as a phase-to-sine mapper (PSM) since the interpolator 30 maps phase signal 25 into the sinusoidal signal 35. Most conventional interpolators, such as interpolator 30, retrieve information from a look up table (LUT). When the interpolator algorithm is an interpolation polynomial, the LUT stores polynomial coefficients, aᵢ, that are retrieved and used for generating the sinusoidal signal. Some interpolators, such as interpolator 20, generate the 2^{nd}, 3^{rd}, and 4^{th} quadrant of the sinusoid signal from the 1^{st} quadrant to take advantage of quadrature symmetry. Such a conversion reduces storage requirements thereby reducing the memory size of the accumulator 20.

Conventional interpolators, such as interpolator 20, often divide the phase signal into equally spaced segments. When there are segments, polynomial coefficients correspond to each segment. The general interpolation polynomial for interpolator 20 is,

A(x)=a₀^{(k)}+a₁^{(k)}x+a₂^{(k)}x²+ . . . +aₙ^{(k)}xⁿ.

The value of each coefficient, aᵢ^{(k)}, is selected in an attempt to minimize the error between a sinusoid and the approximation of the sinusoid generated by interpolator 20.

The quality of the sinusoid signal 35 generated by synthesizer 10 or any synthesizer generally increases as the order of the polynomial increases and/or the number of segments increases. The quality of a synthesizer generated sinusoid signal is generally expressed by finding the spurious free dynamic range (SFDR) of the signal. The SFDR, a known measure of quality, is defined as the ratio of the fundamental harmonic amplitude to the maximum spur amplitude of the generated sinusoid signal, where a spur is a harmonic signal caused by the synthesizer non-idealities. A first sinusoidal signal is of higher quality than a second sinusoidal signal when the first sinusoid signal has a higher value for its SFDR.

The frequency, fₒᵤₜ, of the sinusoid signal from synthesizer 10 and the improved synthesizer 100 of the present disclosure is given by the equation,

$${f}_{out} = \frac{{F}_{r}}{{2}^{L}} {f}_{clk} ,$$

where Fᵣ, L, and f_{clk} are the control signal for the accumulator, the accumulator word length and the clock frequency, respectively. The control signal, Fᵣ, is a number that determines the step size of the phase signal 25.

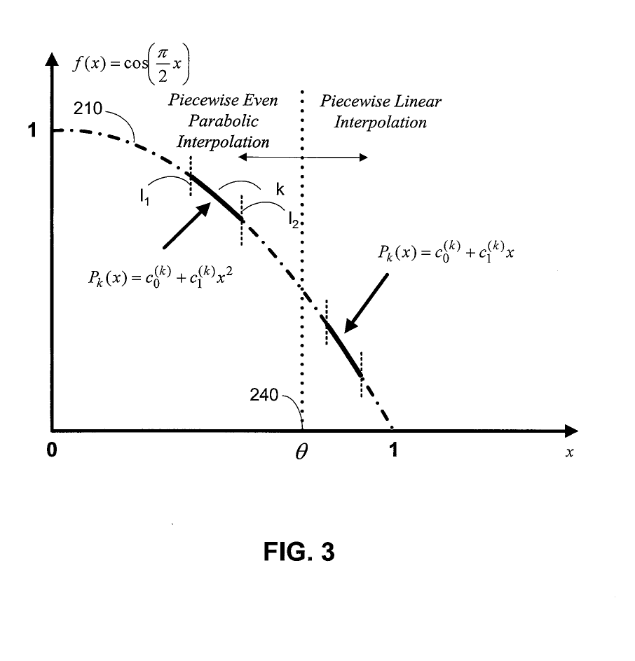

An embodiment of a synthesizer 100 in accordance with the present disclosure is depicted in FIG. 2. Synthesizer 100 has a quasi-linear interpolator 130 (QLIP) that receives phase signal 25, x, from accumulator 20. The QLIP 130 processes the phase signal from the accumulator 20 and generates a sinusoidal signal 135, which can be, for example, a cosine signal or sine signal. In one embodiment, the QLIP 130 generates values for a consine signal in accordance with the equation,

$${P}_{k} = \{ \begin{matrix}{c}_{0}^{( k )} + {c}_{2}^{( k )} {x}^{2} & 1 \leq k \leq θ \\ {c}_{0}^{( k )} + {c}_{1}^{( k )} x & θ + 1 \leq k \leq s ,\end{matrix} 0 \leq x \leq 1 , \qquad ( 1 )$$

where k is the segment number and c₀^{(k)}, c₁^{(k)} and c₂^{(k)} are the polynomial's coefficients. A threshold value 240, θ, in the equation is depicted graphically in FIG. 3. If a value of the phase signal 25 is less than the threshold value 240, then the QLIP 130 processes the phase signal 25 in accordance with the first interpolation polynomial, an even order parabolic polynomial, of equation (1) to generate the sinusoidal signal 135. If the value of the phase signal 25 is greater than the threshold value 240, then the QLIP 130 processes the phase signal 25 in accordance with the second polynomial, a linear polynomial, of equation (1) to generate the sinusoidal signal 135. Hence, the threshold value 240 serves as a boundary that is used for selecting either the first polynomial of Pₖ or the second polynomial for Pₖ. Sets of polynomial coefficients for equation (1) are dependent on the segment number and the threshold value 240. An exemplary segment k is also shown in FIG. 3 as a region between two lines, l₁ and l₂. For some embodiments of the present disclosure, the total number of segments, s, is equal to powers of 2, such as, for example, 4, 16, 32. The curve 210 shows the general shape of a cosine in the first quadrant. As shown by FIG. 2, the digital-to-analog converter 40 converts the sinusoidal signal 135 to an analog signal 145.

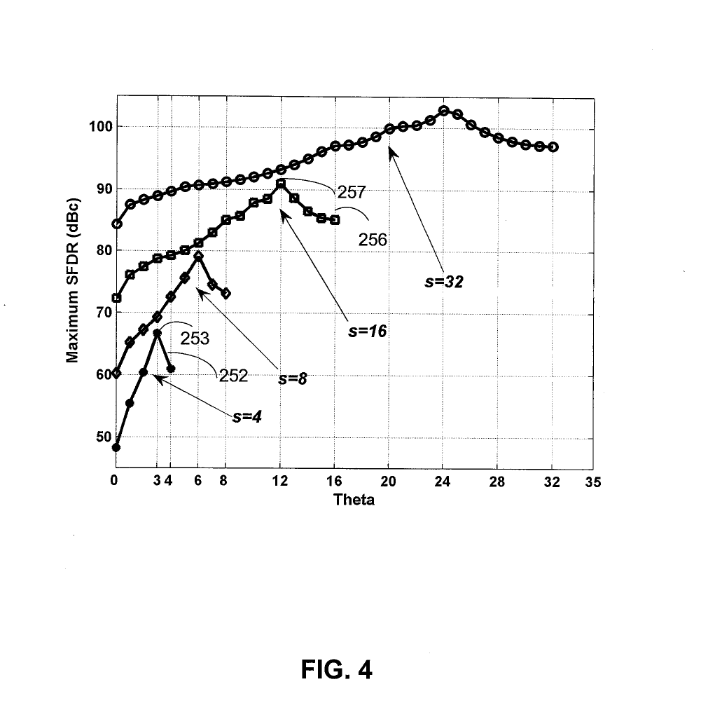

Desirable ranges for the threshold value 240 can be determined by observing the SDFR upper bound values as a function of the number of segments, s, as depicted in FIG. 4. If QLIP 130 has 4 segments, i.e., s=4, represented by curve 252, then a peak value 253 (or the SFDR occurs at the third segment 254. When the number of segments is 16, i.e., s=16, represented by curve 256, then a peak value 257 for SFDR occurs at the 12^{th} segment 258. For some embodiments of the disclosure, the threshold value 240 is equal to ¾ times the number of segments. When expressed as an equation, the threshold value 240, θ=¾s. For other embodiments, other values for θ can be selected. FIG. 4 is also instructive for selecting the number of segments required to obtain a desired SFDR. For example, for the present disclosure, if an SFDR greater than 80 dBc is desired, s should be either 16 or 32 as can be observed in FIG. 4.

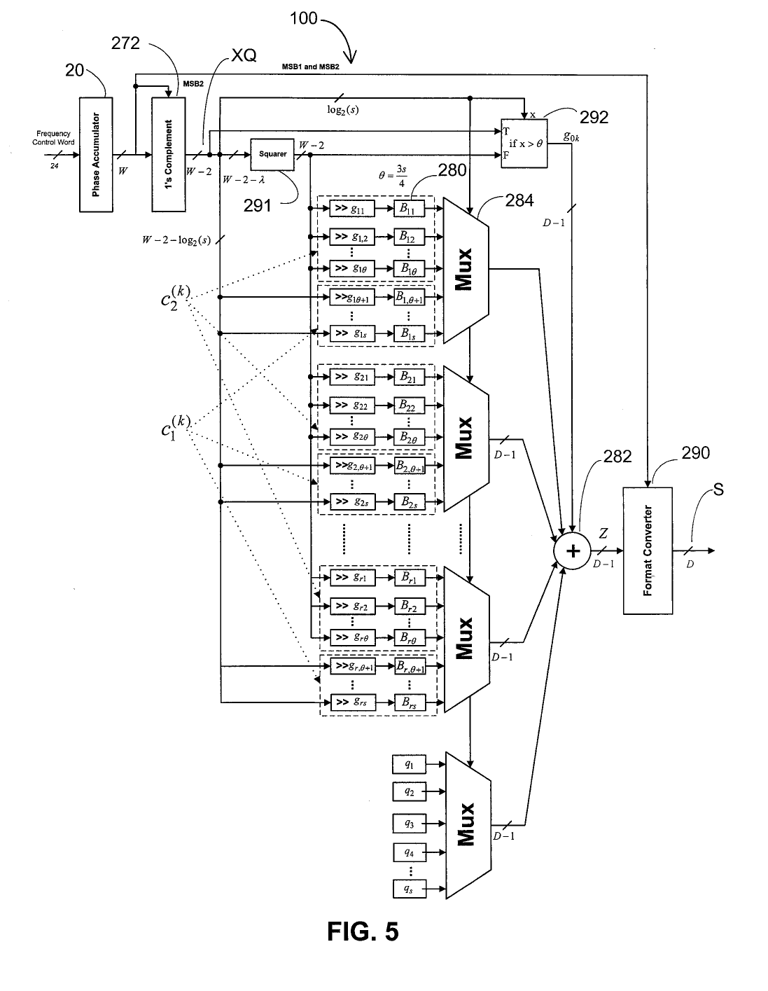

A block diagram depicting an exemplary embodiment of DDFS 100 is shown in FIG. 5. The function of each element of FIG. 5 is to process binary numbers in coordination with other elements such that the functionality is provided to implement an embodiment of synthesizer 100. The numerical simplifications and processing algorithms given below are used to optimize the performance of the embodiment depicted in FIG. 5, i.e., provide a desired SFDR while minimizing the number of processing elements.

The approximations for the digital embodiment of FIG. 5 include quantizing coefficients and variables. To begin the process, the phase values are quantized. The phase quantization is given by

$$x = \frac{n}{{2}^{W - 2}} , 0 \leq n \leq {2}^{W - 2} - 1 , \qquad ( 2 )$$

where W is the phase word length. The quarter wave symmetry of a sinusoid is also used to reduce complexity as well be seen. By substituting the value of x in the polynomial equation, the polynomial equation (2) becomes,

$${P}_{k} [ n ] = \{ \begin{matrix}{c}_{0}^{( k )} + {{c}_{2}^{( k )} ( \frac{n}{{2}^{W - 2}} )}^{2} & 1 \leq k \leq \frac{3 s}{4} \\ {c}_{0}^{( k )} + {c}_{1}^{( k )} ( \frac{n}{{2}^{W - 2}} ) & \frac{3 s}{4} + 1 \leq k \leq s ,\end{matrix} \\ 0 \leq n \leq {2}^{W - 2} - 1. \qquad ( 3 )$$

In order to quantize the amplitude of the above polynomials, the polynomials are multiplied by 2^{D-1} where D is the output word length of the DDFS 100. The result of the multiplication is

$${P}_{k} [ n ] = \{ \begin{matrix}{2}^{D - 1} {c}_{0}^{( k )} + {c}_{2}^{( k )} \frac{{n}^{2}}{{2}^{2 W - D - 3}} & 1 \leq k \leq \frac{3 s}{4} \\ {2}^{D - 1} {c}_{0}^{( k )} + {c}_{1}^{( k )} \frac{n}{{2}^{W - D - 1}} & \frac{3 s}{4} + 1 \leq k \leq s ,\end{matrix} \\ 0 \leq n \leq {2}^{W - 2} - 1. \qquad ( 4 )$$

By substituting W=D+1 in equation (4), the following equations are obtained and are used to implement DDFS 100,

$${P}_{k} [ n ] = \{ \begin{matrix}{2}^{D - 1} {c}_{0}^{( k )} + {c}_{2}^{( k )} \frac{{n}^{2}}{{2}^{W - 2}} & 1 \leq k \leq \frac{3 s}{4} \\ {2}^{D - 1} {c}_{0}^{( k )} + {c}_{1}^{( k )} n & \frac{3 s}{4} + 1 \leq k \leq s ,\end{matrix} \\ 0 \leq n \leq {2}^{W - 2} - 1 , \qquad ( 5 )$$

where the term n²/2^{W-2} represents a fixed-width squarer 291 (FIG. 5). Such a squarer can be implemented using a method described by Kolagotla in Electronics Letters, Vol. 34, No. 1, January 1998.

The next step is to quantize c₁^{(k)} and c₂^{(k)}. To avoid the requirement of a digital multiplier, these coefficients can be approximated by a summation of integer powers of two, which can be realized by logical left and right shifts. Such an approximation is expressed as

$${c}_{i}^{( k )} = {\sum }_{j = 0}^{r} {h}_{jk} {2}^{{g}_{jk}} , \\ {h}_{jk} ∈ \{ + 1 , - 1 \} , \\ i = \frac{sgn ( 3 s / 4 - k ) + 3}{2} , \qquad ( 6 )$$

where gⱼₖ is contained in { . . . ,−2,−1,0,+1,+2, . . .} and hⱼₖ is the sign of each term. The value of r can be indefinitely large, but to obtain a less complex architecture, it can be chosen as small as possible. Additional substitutions provide

$${P}_{k} [ n ] = \{ \begin{matrix}{q}_{k} + {\sum }_{j = 0}^{r} {h}_{jk} 〈 m , {g}_{jk} 〉 & 1 \leq k \leq \frac{3 s}{4} \\ {q}_{k} + {\sum }_{j = 0}^{r} {h}_{jk} 〈 n , {g}_{jk} 〉 & \frac{3 s}{4} + 1 \leq k \leq s ,\end{matrix} \\ 0 \leq n \leq {2}^{W - 2} - 1 , \qquad ( 7 )$$

where (a, b) means that the binary number a has been shifted to the right (b<0) or to the left (b>0) by b bits and the result is truncated to an integer number and

qₖ=└2^{D-1}c₀^{(k)}┘ (8)

where └.┘ is the floor function.

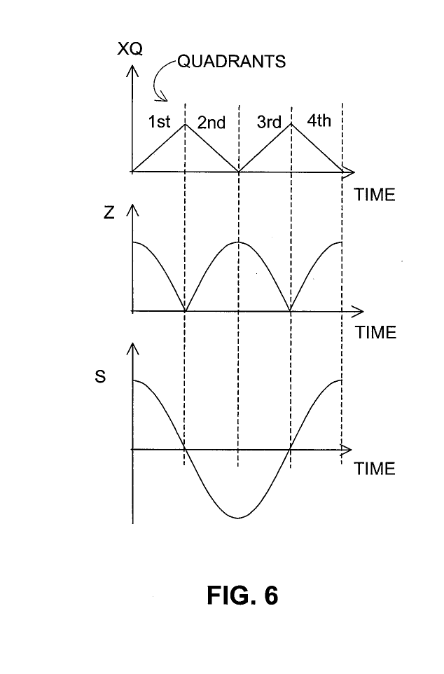

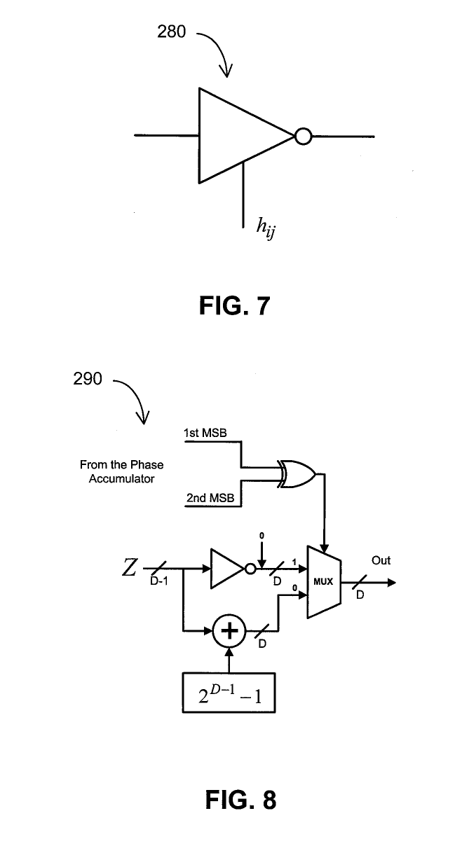

In order to provide a better understanding of the function of the blocks of FIG. 5, several waveforms are depicted in FIG. 6. The word length of variables is shown on the diagram of FIG. 5. For example the word length of the input to accumulator 20 is 24 bits, the word length of the output of the accumulator is “W” bits, and the word length out of a multiplexer 280 is “D-1” bits. The 1's complementor 272 converts the phase signal into the first quadrant from the 2^{nd}, 3^{rd} and 4^{th} quadrants as depicted by the curve XQ of FIG. 6. A comparator 292 compares the phase signal to the threshold value 240 to select the polynomial coefficients used to process the phase signal. The waveform from summer 282, Z, is represented by curve Z of FIG. 6. The format converter 290, converts Z into a sinusoid, S, as shown in FIG. 6. The values for coefficients in the diagram are determined using the approximations given above. Selectively switching between polynomials is based on threshold value θ as described above. Each block containing Bᵢⱼ in FIG. 5 is a conditional complementor as depicted in FIG. 7. The format converter 290 provides the means for translating from sinusoid values from the first quadrant to the 2^{nd}, 3^{rd}, and 4^{th} quadrants and is shown in more detail in FIG. 8.

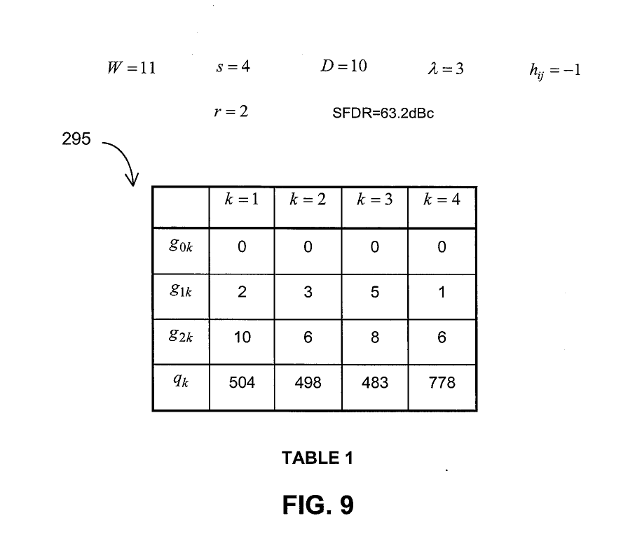

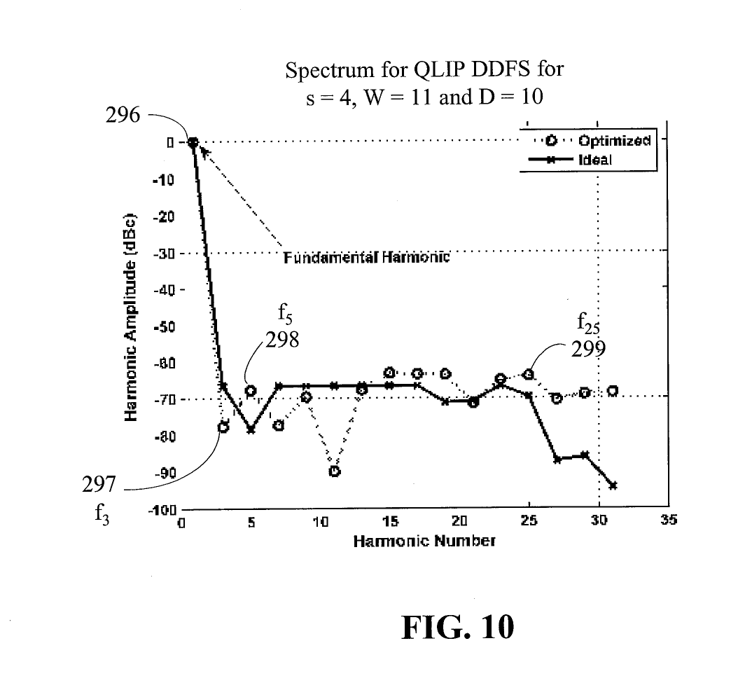

Optimal values for the coefficients can be determined using computer simulations and determining if the performance results are close to the upper bound of the SFDR for the determined values of the coefficients. A table having a set of coefficients, Table 1, for an exemplary embodiment of a DDFS 100 is shown in FIG. 9. The coefficient values in Table 1 were determined through analysis and simulation. A spectrum curve demonstrating the performance of the embodiment of the disclosure using the coefficients of Table 1 is depicted in FIG. 10. The fundamental frequency, f1, shown at location 296 on the spectrum curve has a value of zero dBc. The value of the third harmonic 297, f3, is around −78 dBc, of the fifth harmonic 298, f5, is around −68 dBc. and of the 25^{th} harmonic 299, f25, is around −65 dBc. The SFDR for the embodiment depicted in FIG. 5 is around 63 dBc, which is close to the upper bound of SFDR of 66.64 dBc.

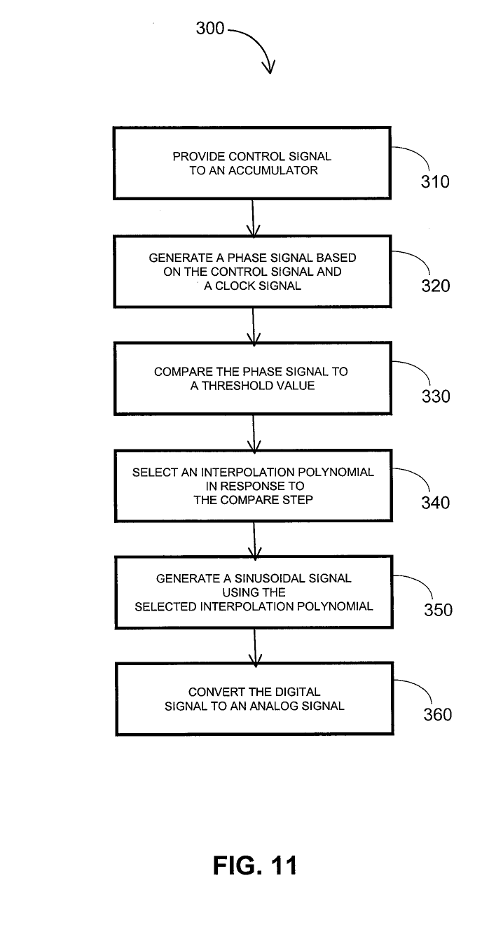

A method embodiment 300 for DDFS 100 is shown in FIG. 11. A control signal is provided to the accumulator 20 that determines the step size of the phase signal 25, step 310. A phase signal 25 is generated in time increments that are determined by the control signal and the accumulator clock frequency, step 320. Phase values are then compared to a threshold value, step 330. Selection of an interpolation polynomial, step 340, is made in response to the results of the comparing step. The selected interpolation polynomial processes the phase value to provide a sinusoid value, step 350. Steps 320 through 350 are repeated in order to generate additional sinusoid values. The sequence of sinusoidal values forms a sinusoid signal for use in a communication or other system. In another embodiment, the digital sinusoidal signal is converted to an analog signal, step 360. It should be further emphasized that the above-described embodiments of the present disclosure are examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure protected by the following claims.

Now, therefore, the following is claimed:

1. A direct digital frequency synthesizer, comprising:
an accumulator that provides a phase signal; and
an interpolator coupled to the accumulator, the interpolator having a table of data where the data is generated based on at least two interpolation polynomials, the interpolator having logic to select data from the table and processes the phase signal using the selected data thereby generating a sinusoidal signal.

2. The synthesizer of claim 1 wherein logic in the accumulator processes a control signal to provide a step size for the phase signal.

3. The synthesizer of claim 1 wherein the interpolator has a comparator that selects data from the table in response to a comparison of the phase signal to a threshold value.

4. A direct digital frequency synthesizer, comprising:
an accumulator that provides a phase signal; and
an interpolator configured to receive the phase signal from the accumulator, the interpolator having a comparator and a table of data where the data is based on two interpolation polynomials, the comparator configured to select data from the table based on a threshold value and to process the phase signal using the selected data, thereby generating a sinusoidal signal.

5. The synthesizer of claim 4 wherein the interpolator generates a cosine signal in the first quadrant and the threshold value is equal to three fourths of the first quadrant phase width.

6. The synthesizer of claim 4 wherein one of the interpolation polynomials is an even order parabolic polynomial and the other interpolation polynomial is a linear polynomial.

7. The synthesizer of claim 4 wherein the phase signal is represented as a binary number with and the two most significant bits determine the quadrant location of the phase signal.

8. A method for synthesizing a sinusoidal signal, comprising the step of:
providing a phase signal;
selecting a set of interpolation polynomial coefficients from one of at least two sets of interpolation polynomial coefficients in response to the phase signal; and
processing the phase signal using the selected set of coefficients, thereby providing a sinusoidal signal.

9. The method of claim 8 where the providing step comprises receiving a step size and a reference clock signal and processing the step size and clock signal to obtain the phase signal.

10. The method of claim 8 wherein the selecting step comprises:
determining a segment number in response to the phase signal;
comparing the segment number with a threshold number; and
retrieving polynomial coefficients corresponding to a first interpolation polynomial if the segment number is less than or equal to the threshold number.

11. The method of claim 10 wherein the selecting step comprises the step of retrieving polynomial coefficients corresponding to a second interpolation polynomial if the segment number is greater than the threshold number.

12. A method for generating a sinusoid, comprising the steps of:
dividing the first quadrant into segments;
selecting a first interpolation polynomial for a first set of the segments;
selecting a second interpolation polynomial for a second set of the segments;
receiving a phase signal having values corresponding to the first quadrant;
comparing the phase signal to a threshold value;
processing the phase signal with the first interpolation polynomial when the phase signal is less than or equal to the threshold value; and
processing the phase signal with the second interpolation polynomial when the phase signal is greater than the threshold value.

13. The method of claim 12 wherein the number of segments is equal to a power of the number 2.

14. The method of claim 13 wherein the threshold number is three fourths of the number of segments.

15. The method of claim 12 wherein the first interpolation polynomial is an even second order polynomial.

16. The method of claim 12 wherein the second interpolation polynomial is a linear equation.

17. The method of claim 12 wherein the coefficients of the polynomials depend on the segment number.

18. The method of claim 13 further comprising the steps of:
determining if the phase signal value is in the first quadrant;
translating the phase signal value to the first quadrant when the phase signal value is not in the first quadrant; and
adjusting the sign of the processing step to correspond with the translating step.

19. The method of claim 15 wherein a fixed-width squarer provides the squaring process for the even second order polynomial.

20. The method of claim 12 having the further step of converting the sinusoidal signal to an analog signal.
